(19) United States
(12) Patent Application Publication
(10) Pub. No.: US 2015/0158263 A1
(43) Pub. Date: Jun. 11, 2015

(54) EMBOSSING APPARATUS AND METHODS USING TEXTURE FEATURES DIGITALLY APPLIED TO A WORK ROLL OR SHEET FOR SUBSEQUENT ROLL EMBOSSING

(71) Applicant: Alcoa Inc., Pittsburgh, PA (US)

(72) Inventors: Dharma Maddala, Pittsburgh, PA (US); Neville Whittle, Irwin, PA (US); June Epp, Pittsburgh, PA (US); Shawn Clark, Lower Burrell, PA (US)

(21) Appl. No.: 14/561,924

(22) Filed: Dec. 5, 2014

Related U.S. Application Data
(60) Provisional application No. 61/912,974, filed on Dec. 6, 2013.

(51) Int. Cl. B31F 1/07

(52) U.S. Cl. CPC B31F 1/07

(57) ABSTRACT

An embossing method and apparatus utilizes 3D printing by digitally dispensing\ink jet printing to apply texturing features to a work roll or a sheet that may be fed into a rolling mill to emboss sheet material like aluminum alloy sheet. The printed pattern is highly variable and may be produced quickly and easily allowing low volume embossing. The printed pattern may be removed from a work roll after use to allow the roll to be reused. Alternatively, a sheet receives the printed pattern, is rolled and then the printed material removed from the resultant depression.

### CROSS REFERENCE TO RELATED APPLICATION

The application claims the benefit of U.S. Provisional Application No. 61/912,974, entitled Embossing Apparatus and Methods Using Texture Features Digitally Applied to a Work Roll or Sheet for Subsequent Roll Embossing, filed Dec. 6, 2013, which is incorporated herein in its entirety.

### FIELD OF THE INVENTION

The present invention relates to embossing and more particularly, to embossing of sheet material, such as metal, polymer or paper.

### BACKGROUND OF THE INVENTION

It is known that sheet material, such as aluminum sheet metal, can be embossed with a desired surface texture by processing in a rolling mill having a work roll with a surface texture. Existing technologies used to create textures on the surface of rolling-mill work rolls include engraving, e.g., via machining, laser processing, or chemical etching, peening and blasting with abrasive media. Some concerns associated with these technologies include: i) expense, ii) high turnaround time for the fabrication of work rolls, and iii) consumption of work roll surface leading to shortened useful life of the roll. In general, the cost of known embossing processes, e.g., as measured by the performance of the pattern vs. cost per square foot of embossed product produced, is high. A large portion of this cost is attributable to the fabrication of the working rolls and more particularly to the development of the texture on the surface of the rolls that is transferred to the sheet (in reverse) when embossing occurs. The high costs of production of embossed sheet may be economically feasible for high volume production runs, but become less so for short, custom production runs. While the blasting approach to texturing the surface of embossing rolls is cheaper, the resultant surface patterns/textures available are random. Random patterns are suitable for certain applications, but non-random textures are desirable for other applications, such as sheet for furniture, architectural products, consumer electronics, lighting applications, building and construction materials. It is difficult and expensive to generate a custom-designed non-random pattern/texture, e.g., using laser engraving or custom etching of the work rolls for applications such as aluminum thread plate or any other coining operations for sheet metal or for embossing rolls with custom patterns in the paper industry. In addition to the foregoing, conventional surfacing processes, such as peening, electronic discharge texturing, etc., change the roll surface characteristics, producing recast layers, oxidation, micro cracking, residual stresses, and/or hydrogen embrittlement, which may lead to shortened roll life and/or diminished embossing effectiveness.

### SUMMARY OF THE INVENTION

The present disclosure relates to a method for embossing material, including the steps of depositing media on an embossing element and pressing the embossing element with deposited media into the material to be embossed.

In another embodiment, the media is applied to the embossing element in a flowable state and hardens prior to the step of pressing.

In another embodiment, the material is in the form of a sheet, the embossing element is a work roll and the media is deposited on the work roll by printing.

In another embodiment, the printing is 3D printing.

In another embodiment, further including the step of removing the media from the work roll after pressing.

In another embodiment, further including the step of printing more media on the work roll after the step of removing and then embossing material with the work roll.

In another embodiment, the media is digitally dispensable ink jet printable polymer and the step of removing includes exposing the media to an alkaline cleaner.

In another embodiment, the sheet is made from aluminum alloy.

In another embodiment, the work roll is a first work roll and further including the step of depositing media on a second work roll and embossing the sheet on two sides by passing the sheet between the first and second work rolls.

In another embodiment, the embossing element is a web and the step of pressing is conducted by positioning the web with deposited media next to the sheet and passing the web and the sheet through a pair of work rolls.

In another embodiment, further including the step of depositing media on a second web and positioning the second web next to the sheet, distal to the first web and the passing the first web, the second web and the sheet though the pair of work rolls.

In another embodiment, the web is paper.

In another embodiment, a method for embossing a sheet of material includes the steps of depositing media in a flowable state on the sheet of material; allowing the media to harden; pressing the hardened media into the sheet of material; and removing the hardened media from the sheet, leaving depressions therein.

In another embodiment, the step of depositing is conducted by 3D printing.

In another embodiment, the media is digitally dispensable ink jet printable polymer and the hardened media is removed by exposure to alkaline cleaner.

In another embodiment, the step of depositing includes the step of metering a volume of media for each pixel of a plurality of pixels forming an embossing pattern.

In another embodiment, an apparatus for embossing sheet material includes an embossing substrate, a dispenser for dispensing media on the embossing substrate and an apparatus to press the embossing substrate with applied media into the sheet.

In another embodiment, the dispenser is a 3D printer.

In another embodiment, the embossing substrate is a work roll and the apparatus to press the embossing substrate is a rolling mill.

In another embodiment, the embossing substrate is a flexible web and the apparatus to press the embossing substrate is a rolling mill.

In another embodiment, a media remover has a dispenser of alkaline cleaner that dissolves the media when the media is exposed thereto.

In another embodiment, the embossing substrate is a plate and the apparatus to press the embossing substrate is a press.

In another embodiment, further including a layer of adhesion promoter applied to the embossing substrate and a seed layer of media disposed over the adhesion promoter upon which the media is dispensed to form an embossing pattern.

In another embodiment, the media is UV curable.

### BRIEF DESCRIPTION OF THE DRAWINGS

For a more complete understanding of the present invention, reference is made to the following detailed description of exemplary embodiments considered in conjunction with the accompanying drawings, in which:

FIG. 1 is a perspective view of a system and method for imparting an embossing texture to the surface of a work roll in accordance with an embodiment of the present disclosure.

FIG. 2 is an enlarged schematic view of a portion the system and method of FIG. 1.

FIG. 3 is an enlarged view of a portion of the work roll and embossing texture of FIGS. 1 and 2.

FIG. 4A is an enlarged cross-sectional view of the work roll and embossing texture of FIGS. 1 and 2.

FIGS. 4B and 4C are cross-sectional views of a work roll and embossing textures like FIG. 4A, but showing two different embossing textures.

FIG. 5 is a schematic view of an embossing apparatus and method in accordance with another embodiment of the present disclosure.

FIG. 6 is a perspective view of an embossing apparatus and method in accordance with another embodiment of the present disclosure.

FIG. 7 is an enlarged view of a portion of the embossed sheet shown in FIG. 6.

FIG. 8A is a cross-sectional view of the embossed sheet of FIGS. 6 and 7.

FIGS. 8B and 8C are cross-sectional views like FIG. 8A, but showing different embossing patterns.

FIG. 9 is a schematic view of a texture removal system and method in accordance with another embodiment of the present disclosure.

FIG. 10 is a perspective view of an embossing apparatus and method in accordance with another embodiment of the present disclosure.

FIG. 11 is a schematic view of an embossing apparatus and method in accordance with another embodiment of the present disclosure.

FIG. 12 is a perspective view of an embossing apparatus and method in accordance with another embodiment of the present disclosure.

FIG. 13 is a schematic view of the embossing apparatus and method of FIG. 12.

FIG. 14 is a perspective view of a pair of sample plates upon which an embossing pattern has been printed in accordance with another embodiment of the present disclosure.

FIG. 15 is a computer generated image representing measured surface topography of a portion of one of the plates shown in FIG. 14.

FIG. 16 is a 3D computer generated image representing measured surface topography of the portion shown in FIG. 15.

FIG. 17 is a computer generated image representing measured surface topography of a sample surface embossed by one of the plates shown in FIGS. 14-16 in accordance with another embodiment of the present disclosure.

FIG. 18 is a 3D computer generated image representing measured surface topography of the embossed surface shown in FIG. 17.

FIG. 19 shows a group of plates upon which different embossing patterns have been printed in accordance with another embodiment of the present disclosure.

FIG. 20 is a computer generated image representing measured surface topography of a portion of one of the plates shown in FIG. 19.

FIG. 21 is a 3D computer generated image representing measured surface topography of the portion shown in FIG. 20.

FIG. 22 is a computer generated image representing measured surface topography of a sample surface embossed by one of the plates shown in FIGS. 19-21 in accordance with another embodiment of the present disclosure.

FIG. 23 is a 3D computer generated image representing measured surface topography of the embossed surface shown in FIG. 22.

FIGS. 24 and 25 are perspective views of rolls, an outer surface of which is printed with an embossing pattern in accordance with another embodiment of the present disclosure.

FIG. 26 is a graph of yield strength for different alloys with different thicknesses.

FIGS. 27-33 are computer generated images representing measured surface topography of portions of sample surfaces made from different alloys and embossed by a roll like that shown in FIGS. 24 and 25 in accordance with another embodiment of the present disclosure.

FIG. 34 is a graph of indentation depth of different sample surfaces of different alloys.

FIG. 35 is a graph of indentation depth and yield strength for different alloys of different thicknesses.

### DETAILED DESCRIPTION OF THE EXEMPLARY EMBODIMENT

The disclosures of U.S. application Ser. No. 13/892,028 entitled, Apparatus and Method for Imparting Selected Topographies to Aluminum Sheet Metal, filed May 10, 2013; U.S. application Ser. No. 13/673,468 entitled, Apparatus and Method for Imparting Selected Topographies to Aluminum Sheet Metal, filed Nov. 9, 2012; and U.S. Provisional Application No. 61/557,504, entitled, Apparatus and Method for Imparting Selected Topographies to Aluminum Sheet Metal, filed Nov. 11, 2011 are incorporated by reference herein in their entirety.

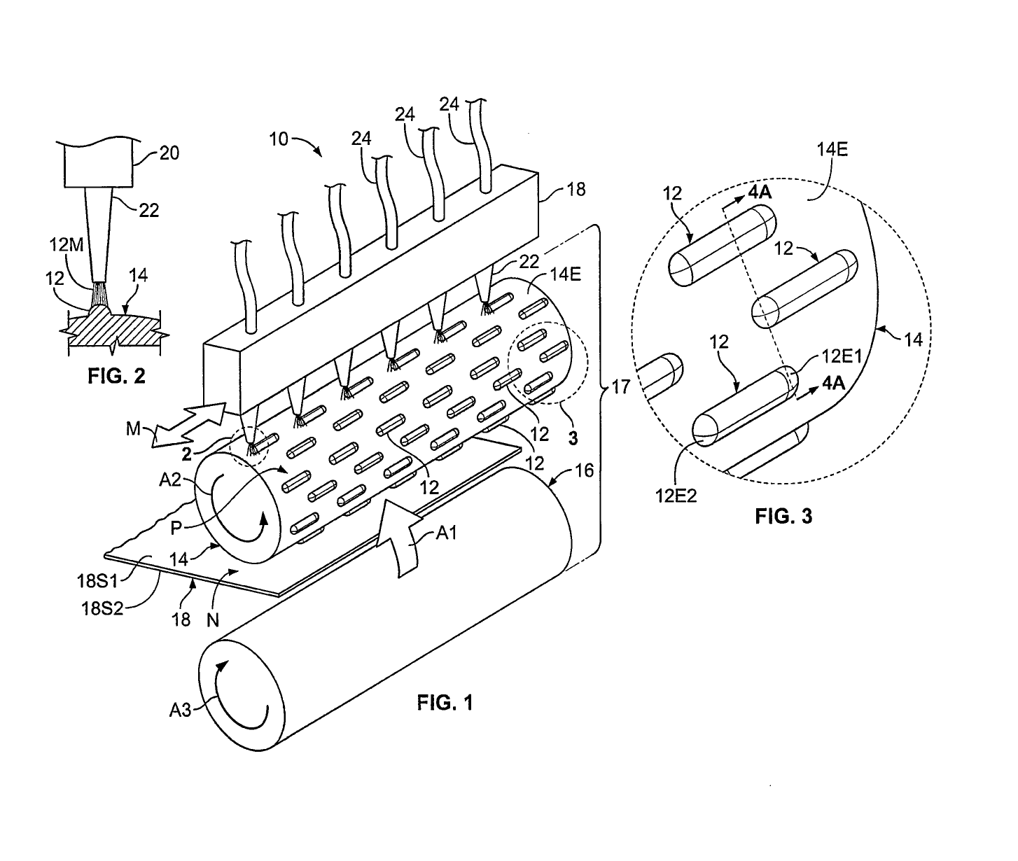

FIGS. 1-3 illustrate a dispenser system 10 depositing a plurality of embossing features/appliques 12 to an external surface 14E of a work roll 14 to form a pattern P thereon. The work roll 14 may be made from a steel alloy e.g., cast or GP rolls from Gontermann-Peipers of Siegen, Germany, that are surface-coated with chrome or a ceramic protective layer and may have a smooth exterior surface 14E, e.g., a mirror finish. Auxiliary rolls may be made from metal, polymer or rubber. Alternatively and depending upon the composition of the appliques 12, it may be beneficial to provide the work roll 14 with a given surface roughness to increase adherence of the appliques 12. To achieve a desired surface roughness, the work roll 14 may be preliminarily textured by grinding, blasting, peening, coating, etching, electronic discharge texturing (EDT) or other surfacing processes. The work roll 14 may have a wear-resistant coating applied to it prior to receiving the appliques. In one embodiment, work roll 14 may be a conventional steel work roll used for skin pass/embossing and cold rolling.

The dispenser system 10 may be digitally (computer) controlled, e.g., in the manner of known digital printers. Further, the dispenser system 10 may utilize 3D printing technology, e.g., as exhibited by commercially available 3D printers. In this disclosure, the term “applique” is used to describe a three dimensional feature (element or embossment) deposited on an exterior surface 14E of an embossing element, such as a work roll 14. The applique 12 may be applied as a liquid, gel or semi-solid that subsequently hardens, e.g., into a more rigid form, e.g., by cooling, curing or polymerization. Various materials may be used as the media 12M for printing the appliques 12, including ink jet printable polymers, UV curable polymers, ABS plastics, PLA's, polyamides, glass filled polyamides, polycarbonates, epoxy resins, waxes, ceramics, such as fine/submicron size alumina powders, silicon nitride, lead zirconate titanate and other fine crystalline/nanocrystalline/amorphous ceramic powders and metals such as aluminum, steel, titanium, silver etc. Metals may be directly printed from a melt. Alternatively, a suspension of metallic particles may be printed, and the printed suspension heat treated or sintered to bond the metallic particles together. In another approach, a metal compound may be printed and then chemically reduced to form the printed metal. In accordance with another embodiment, the printed metal may be plated, with one or more additional layers, e.g., using electroplating, to produce a deposit having desired properties, pertaining to hardness, ductility, abrasion resistance, etc. In a similar manner, ceramics may be printed by printing a suspension of fine ceramic powder blended with adhesive and other materials to achieve a workable viscosity and then jetted onto the target surface. The suspension may be allowed to cure by drying or firing. Polymers may be directly printed from a melt of polymer or low molecular weight wax that solidifies on cooling. Alternatively, polymers may be printed as oligomers and then cured with an ebeam of UV radiation. In another alternative, a polymer solution may be printed followed by evaporation of the solvent.

The appliques 12 printed on the work roll 14 using 3D printing technology may have a three dimensional shape built up by several passes, as is typical of 3D printing processes. An aspect of the present disclosure is the recognition that 3D printing may be utilized to apply a 3D texture defined at least partially by appliques 12 adhered to a work roll 14 by directly printing the appliques 12 on the work roll 14. The appliques 12 may all be of the same geometric form or may be of differing forms. The appliques 12 formed by multiple passes to yield a plurality of layers may have layers of the same material or may have layers of different materials, leading to a composite applique 12. Similarly, the printing of the appliques 12 may be done using a plurality of different materials/media 12M that are deposited in different areas, in a similar manner to which a color picture is printed with different colors covering different areas of a substrate on which it is printed. The appliques 12 may also be of different heights for different areas printed and the three dimensional shapes of the appliques 12 may be complex both individually and with respect to the resultant cumulative pattern P that covers the surface 14E on which they are printed. As with pixelated imaging and 3D printing generally, a great amount of variability is possible, allowing an unlimited number of patterns P of appliques 12 of different shapes to be printed, for example, patterns P generated from photographic images or from algorithmically (computer) generated images.

In one embodiment, work roll 14 may be used in conjunction with another roll 16 that can be moved into close, parallel proximity (as indicated by arrow A1) in a rolling mill or embossing mill 17, for embossing a sheet of material 18, such as a sheet of aluminum alloy metal, a polymer, paper or steel, which is passed there between. The work rolls 14, 16 are rotated as indicated by arrows A2, A3 by electric motors or the like, causing the sheet 18 to pass through the nip N defined by the spacing between the rolls 14, 16, which may be variable and/or the work rolls 14, 16 may be resiliently urged together. The mill 17 can also be coiler driven, as in a typical embossing mill. In the embodiment shown in FIG. 1, if work roll 16 is made from a hard material, such as steel and has a smooth outer surface, only surface 18S1 is embossed by the texture produced by the pattern P of appliques 12 on work roll 14, with surface 18S2 being smooth. In another embodiment, if work roll 16 is made of or coated by a layer of resilient material, such as rubber, the indentations made in the sheet 18 by the appliques 12 may telegraph through the sheet 18 to the opposing surface 18S2, depending upon the thickness and hardness of the sheet 18 and the dimensions and composition of the appliques 12.

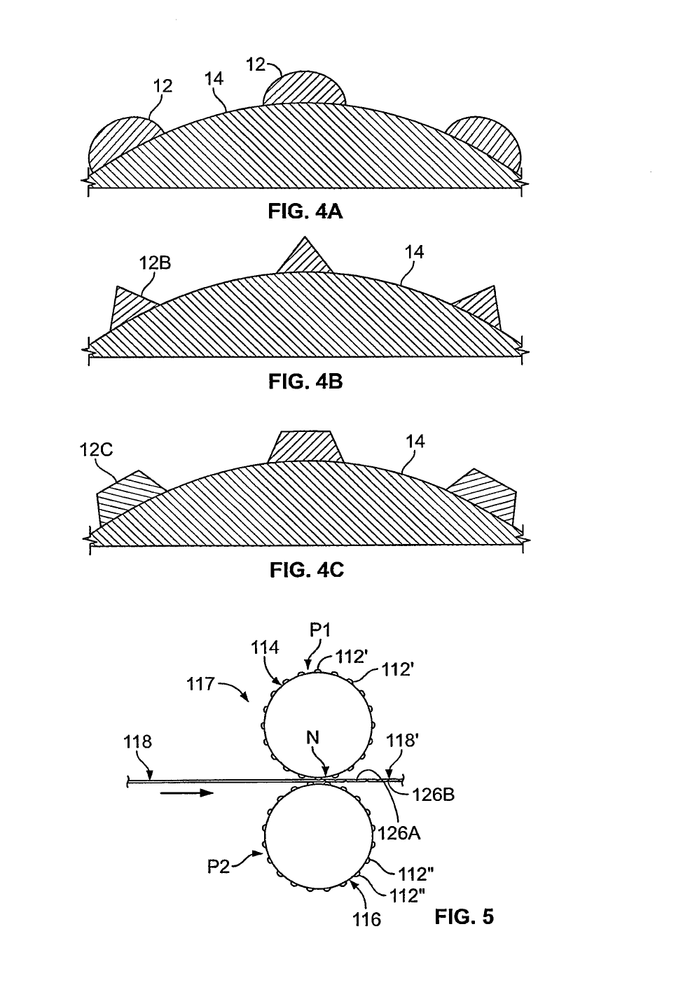

The dispenser system 10 includes a dispensing module 20 with a plurality of dispensing heads 22 (in the terminology of printing and 3D printing, “print heads”). The dispensing module 20 can use any technology of ink jet printing such as CIJ (continuous ink jet), DOD (drop on demand) or other types of printing. The dispensing module 20 may be connected to one or more feed lines 24 that may supply media 12M, e.g., in liquid form, from a media reservoir (not shown) and/or supply electrical control via signal wires through which a computer can control dispensing of media by the dispensing heads 22 and/or the movement of the dispensing heads 22 relative to the dispensing module 20 and/or the work roll 14. In the event that the media 12M provided to each of the dispensing heads is the same, then a single feed line 24 may supply all of the dispensing heads 22 mounted on the dispensing module 20, which may be ported to distribute media 12M to each of the plurality of dispensing heads 22. The number of dispensing heads 22 is variable and the greater the number, the quicker the media 12M can be dispensed onto the work roll 14, in that multiple appliques 12 can be deposited simultaneously. Alternatively, the appliques may be deposited sequentially. As noted above, the media 12M supplied to the plurality of dispensing heads 22 may be different from one dispensing head 22 to another, in which case they must be provided with individuated feed lines 24. In one embodiment, the dispensing module 20 can be moved (indicated by the arrow M) as a unit by a mechanism, such as a linear motor or a robotically controlled arm (not shown) to reposition each of the dispensing heads 22 simultaneously. Simultaneous movement of a plurality of dispensing heads 22 may accelerate dispensing to form a repetitious pattern P of like appliques 12 if the dispensing heads 22 are activated simultaneously. In the event that the pattern P is repetitious, the electronic control of dispensing may be conducted by a single signal that is distributed by a gang connection to each of the plurality of dispensing heads 22. As can be seen in FIGS. 3 and 4A, the appliques 12 may be in the form of elongated beads having a semi-circular cross-section and rounded ends 12E1, 12E2. FIGS. 4B and 4C show appliques 12B and 12C with triangular and quadrangular cross-sectional shapes, respectively. As noted, the flexibility of 3D printing allows appliques 12 of any given profile and cross-sectional shape to be deposited on a substrate, such as a work roll surface 14E. As in embossing generally, the negative or reverse impression of the pattern P on the work roll 14 is transferred to the embossed sheet 18 when embossing is carried out, i.e., male features on the work roll 14 emboss the sheet 18 with corresponding female features and vice versa. The media selected for forming the appliques 12 preferably has an endurance sufficient to transfer the embossment pattern P to the sheet 18′ with fidelity and to withstand the production of a length of embossed sheet 18′ which bears a satisfactory relationship to the economic value of the embossed sheets produced. If an embossing production run is completed and/or a given pattern P of appliques 12 wears to a point where embossing is degraded and unsatisfactory, the work roll(s) 14 may be recycled by removing the appliques 12, either mechanically, e.g., by a scraper, grinder or cutter, chemically with an alkaline cleaner or solvent or by heating/cooling, alone or in combination with another of the removal methods, e.g., heating and scraping after treatment with an alkaline cleaner.

FIG. 5 shows an embodiment of the present disclosure wherein both the work rolls 114 and 116 are assembled as a rolling mill 117 and have similar appliques 112′ and 112″ and a similar pattern P1, P2 of appliques 112. The appliques 112′, 112″ are offset at the nip N to interdigitate, producing a sheet 118′ from sheet 118 with spaced, interposed indentations 126A and 126B on opposing sides of embossed sheet 118′. The sheet 118 may be made of aluminum, aluminum alloy, steel, paper, plastic, or other types of metallic sheet. The rolling/embossing process conducted by rolling mill 117 may be a low reduction rolling operation such as an embossing/skin pass rolling process. Alternatively, depending upon the hardness of the sheet 118 and the appliques 112′, 112″, the embossing process may be a high reduction rolling process. The transfer efficiency of the imprint that is made in the sheet 118 by the work rolls 114, 116 with their respective appliques 112′, 112″ depends upon the load applied to the rolls 114, 116, urging them together, the characteristics of the media 112M, and the rolling contact conditions (e.g., the size of the rolls 114 and 116).

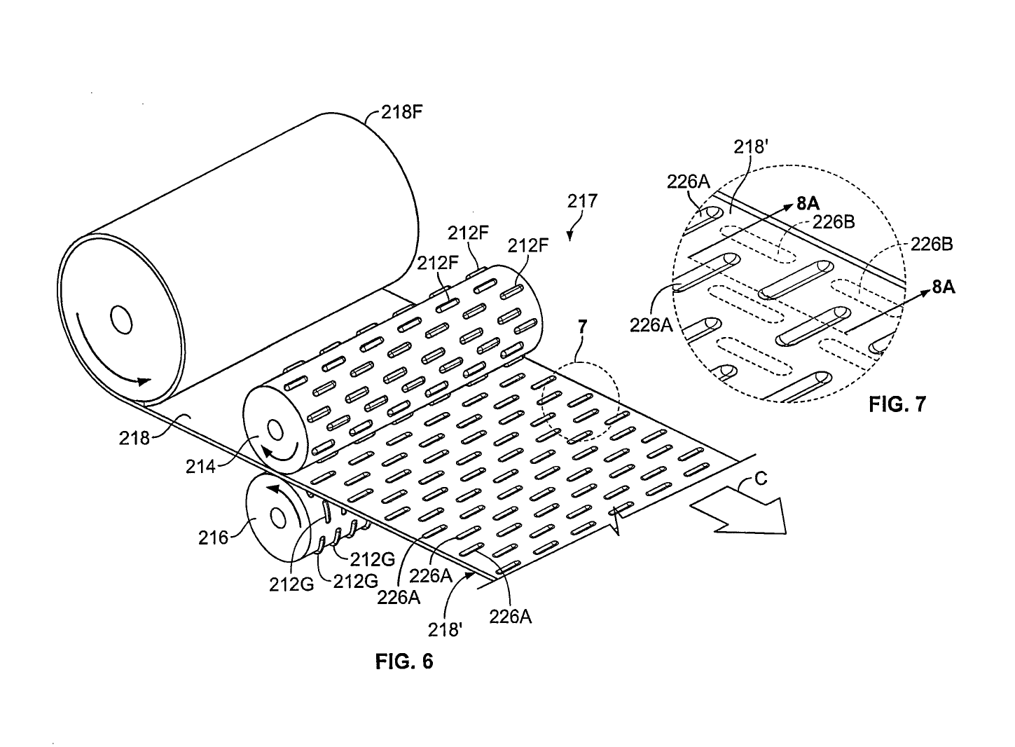

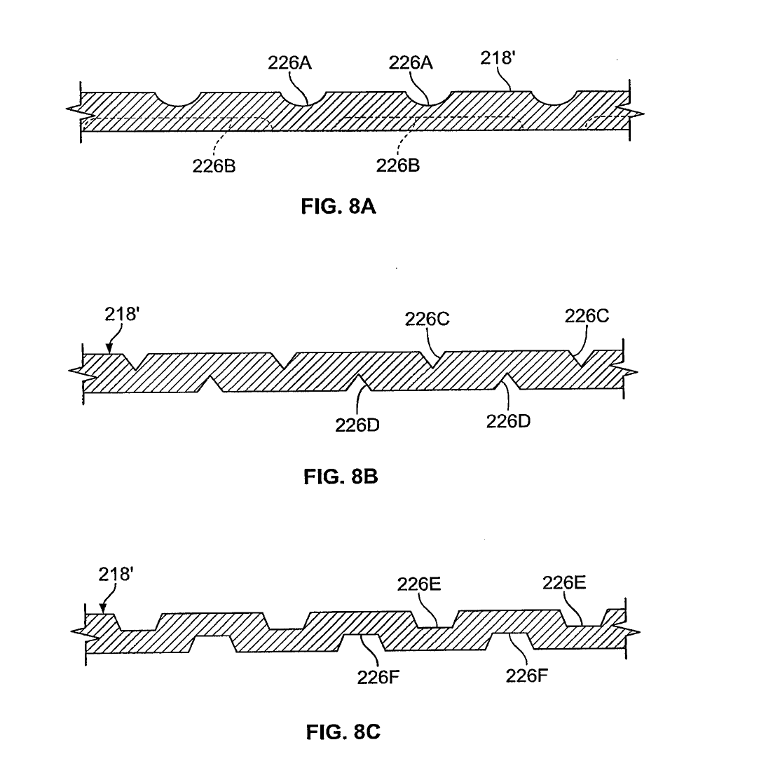

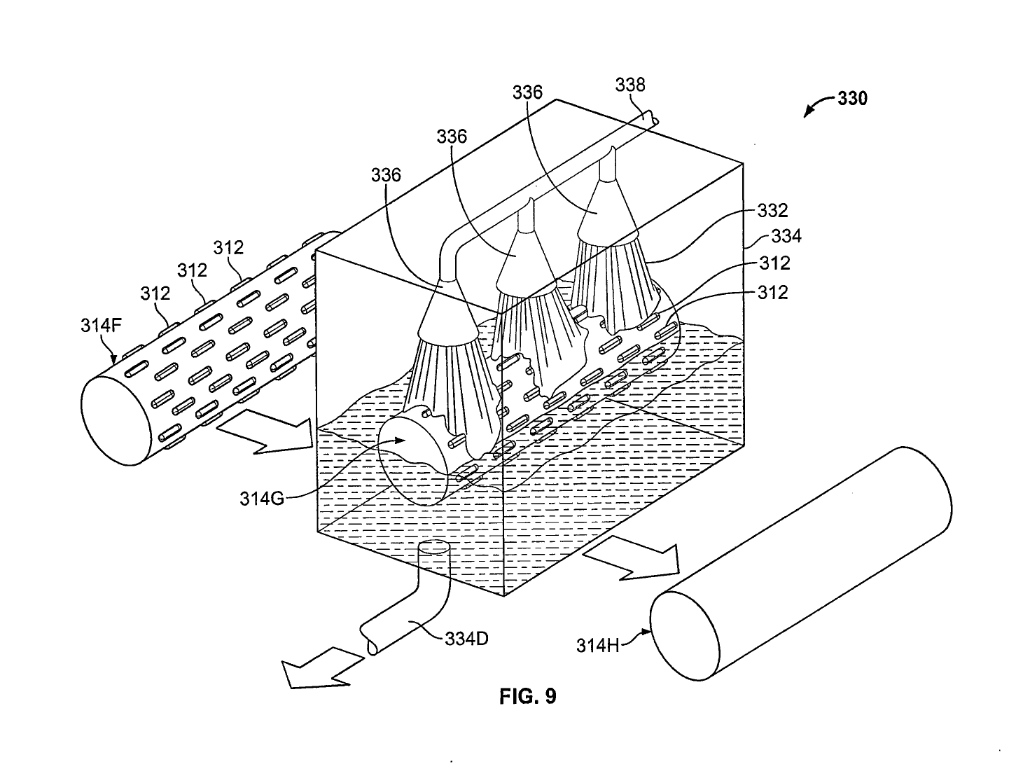

FIGS. 6, 7 and 8A show a similar embossing process as that shown in FIG. 5 with the exception that the appliques 212F and 212G on work rolls 214, 216, respectively, are oriented at 90 degrees relative one another, producing a sheet 218′ with indentations 226A and 226B intermittently spaced on either side of the sheet 218′ and oriented at 90 degrees relative one another. FIG. 8B shows an embossed sheet 218′ having indentations 226C, 226D made by interdigitating, triangularly shaped appliques like appliques 12B depicted in FIG. 4B. FIG. 8C shows an embossed sheet 218′ having indentations 226E, 226F made by interdigitating, quadrilaterally shaped appliques like appliques 12C depicted in FIG. 4C.

FIG. 9 shows an applique removal apparatus 330 and process for removing appliques 312, e.g., made from ink jet printed/digitally dispensed polymer media from a work roll 314F with an alkaline cleaner for industrial application 332, such as those produced and commercialized by Henkel of Dusseldorf, Germany and other companies. A work roll 314F (signifying an initial state) having appliques 312 is prepared for recycling and reapplication of appliques 312 by supporting same in a container 334. One or more outlets 336 from conduit 338 discharge solution 332 onto the work roll 314G (signifying a state of being processed) to dissolve the appliques 312. The conduit 338 is fed by a reservoir of solution 332 (not shown). The work roll 314G may be rotatably supported, allowing the work roll 314G to be turned to expose different portions of the appliques 312 to the solution 332. The container 334 may be dimensioned to retain a volume of the solution 332 forming a bath of solution 332 in which the work roll 314G is partly or fully immersed. When the appliques 312 are dissolved from the work roll 314H (signifying a completed state in which the appliques 312 are removed), the work roll 314H may be removed from the container 334 and further processed, e.g., rinsed, dried and prepared for application of new appliques 12. Used alkaline cleaner 332 may be drained via drain 334D continuously or periodically, as needed and may be reused. The work roll 314H can thereafter be used to print another texture/pattern and can therefore be reused for embossing multiple times, without the loss of roll material. The present disclosure allows the preparation of rolls economically and quickly, allowing short runs of custom embossing to be conducted with reasonable cost and with a quick turnaround. Direct 3D printing of the appliques 312 on work roll(s) 314F permits rapid development of applique 312 patterns P and changing of the pattern due to ease in forming and removing the pattern P and reusing the work roll 314H. Work rolls 314 may be provided with a hard uniform coating with minimal pits and defects, high adhesion and desired density, that allows the work rolls 314F-314H to be recycled and reused many times.

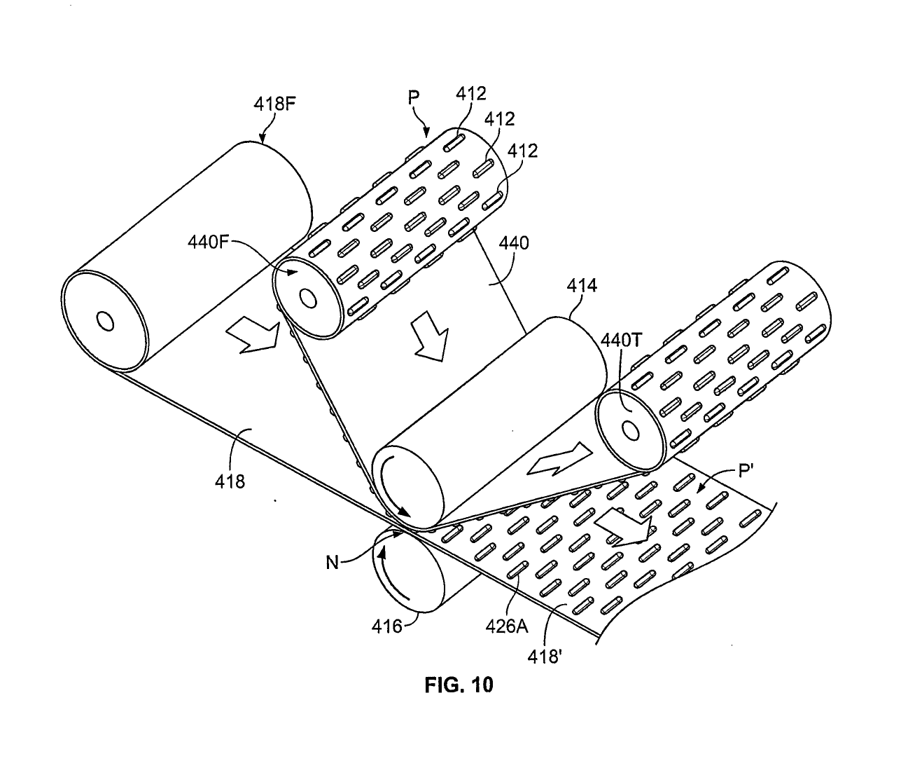

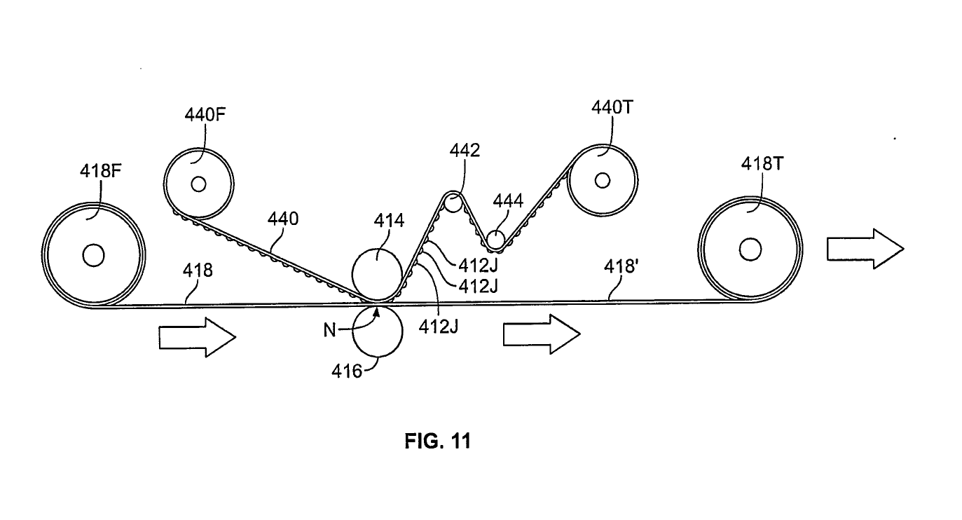

FIGS. 10 and 11 show another embodiment of the present disclosure wherein appliques 412 have been printed on a carrier web 440, e.g., made from paper, Mylar, Tyvek, or other flexible web material. The appliques 412 may be printed on the carrier web 440 using the same techniques, e.g., 3D printing, that are used to print the appliques 12 on work rolls 14 and they may be made of the same or similar materials described above. The carrier web 440 may be collected on a feed roll 440F from which the web 440 is fed through a pair of work rolls 414, 416, that may be either smooth or one or both may have an embossing pattern thereon. The sheet material 418 to be embossed is taken from a sheet feed roll 418F and passed through the opposed rolls 414, 416 along with the carrier web 440 bearing the appliques 412. In one embodiment, the appliques 412 are deposited on one side of the carrier web 440, which, as shown, is positioned proximate to the sheet 418 to be embossed. Upon passing through the nip N between work rolls 414, 416, the sheet 418 is embossed to form an embossed sheet 418′ with a surface pattern P′ reflecting the pattern P on the carrier web 440. After having passed through the nip N, the carrier web 440 is taken up by take up roll 440T for reuse or recycling, as determined by the condition of the web after embossing. In another embodiment, a carrier web 440 may be fed through the nip N on both sides of the sheet 418 in order to emboss both sides of the sheet. FIG. 11 shows take-up roll 418T for the embossed sheet 418′ and tensioning/redirecting rolls 442, 444 that tension and reposition the carrier web 440 after it has passed through the nip N.

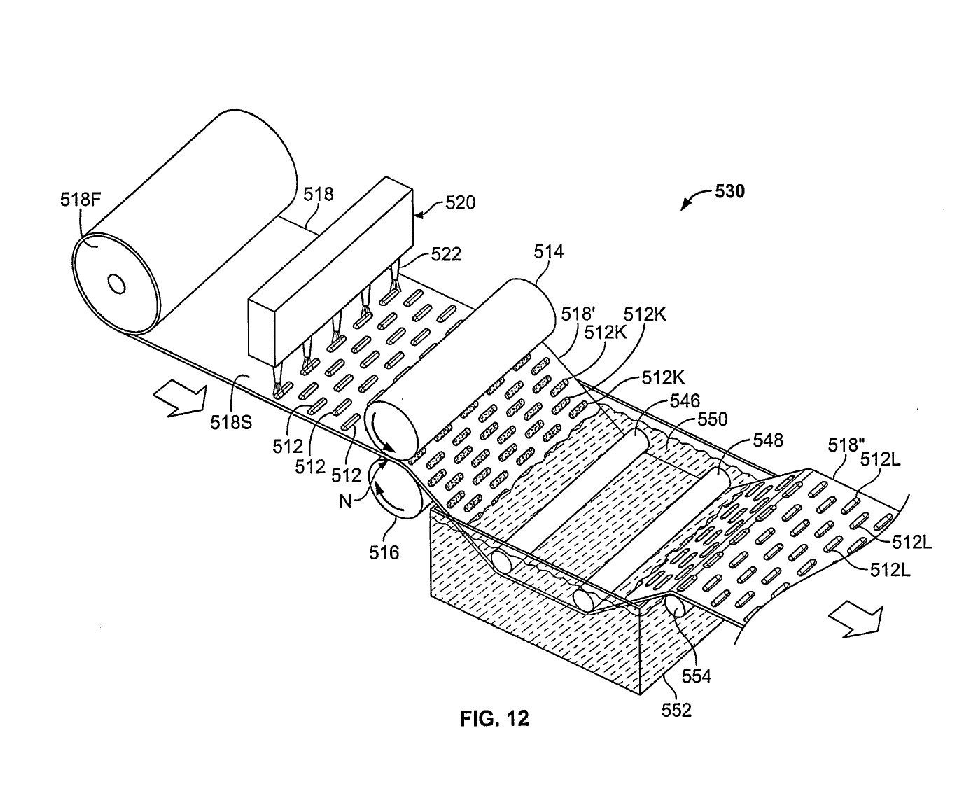

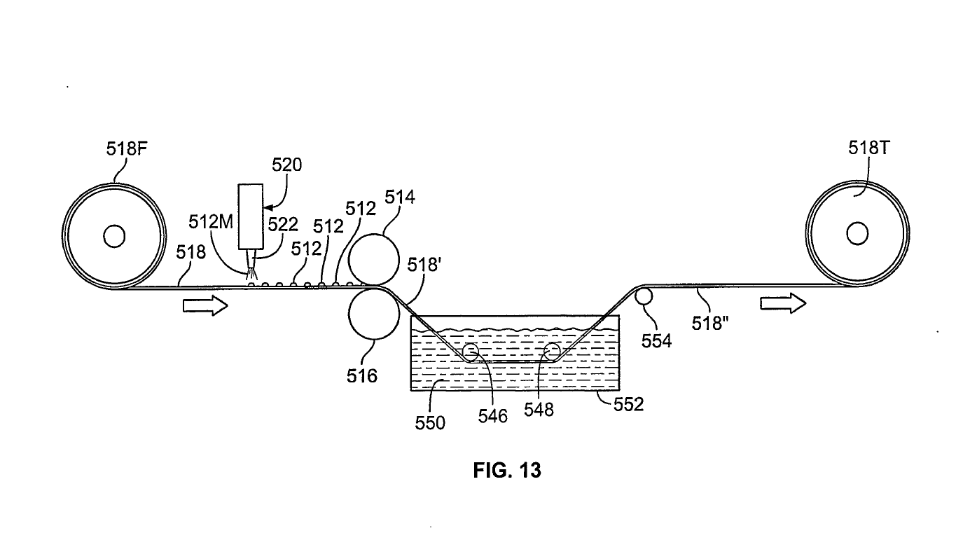

FIGS. 12 and 13 show a system 530 in accordance with another embodiment of the present disclosure wherein a sheet 518, e.g., of aluminum alloy, is pulled from a feed roll 518F and passed below a dispensing module 520. As the sheet 518 passes the dispensing module 520, the dispensing heads 522 dispense appliques 512, e.g., composed of digitally dispensed or ink jet printed polymer media onto the surface 518S of the sheet 518. The distance between the dispensing module 520 and the rolls 514, 516 and the rate of sheet advance are chosen to allow the appliques 512 to harden before passing through the nip N between working rolls 514, 516. When the appliques 512 on the surface 518S of the sheet 518 pass through the nip N, the pressure of the opposing rolls presses the appliques 512 into the surface of the sheet 518, resulting in embossing of the sheet 518′. The embossed sheet 518′ with appliques 512K pressed into the surface 518S is then directed by guide rolls 546, 548 into a bath 550, e.g., of industrial alkaline cleaner contained within tank 552, which dissolves the impressed appliques 512K, leaving an embossed sheet 518″ from which the appliques 512K have been removed from hollow depressions 512L. Guide roll 554 guides the embossed sheet 518″ to take-up roll 518T.

### Example 1

### Printing on a Flat Sheet

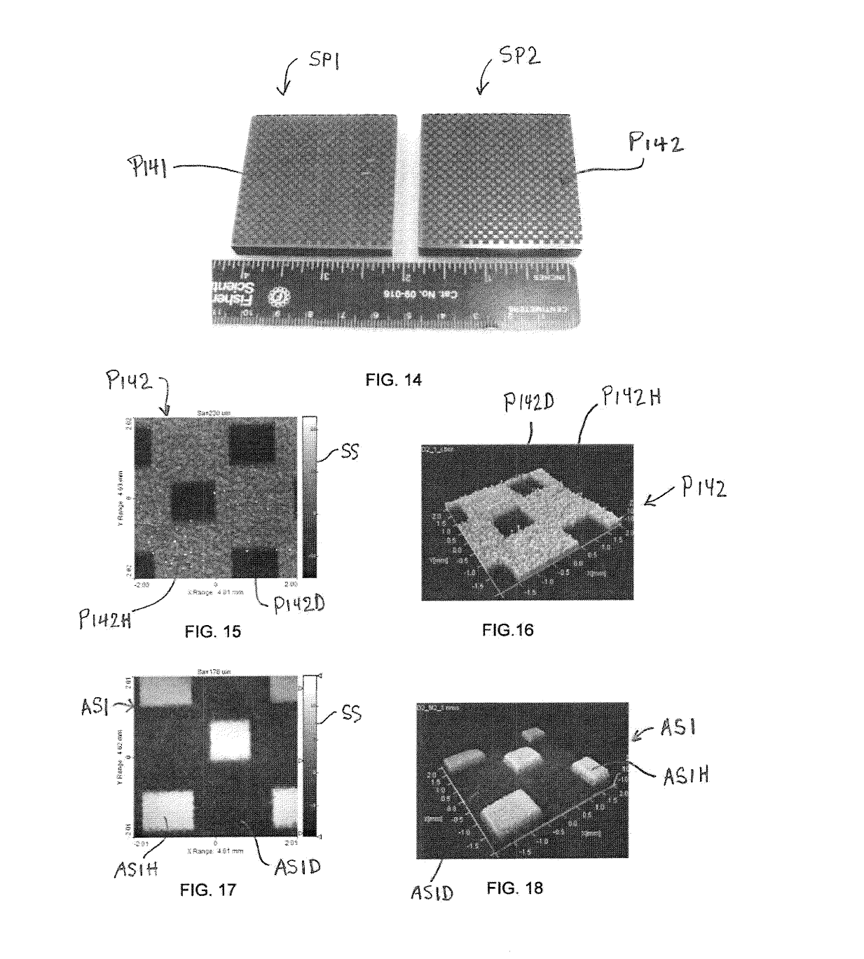

Using ink jet printing (by digital dispensing) a UV curable polymer was printed onto flat steel plate substrates. FIG. 14 shows a pair of sample plates SP1, SP2, upon which an embossing pattern P141 and P142 was printed. FIG. 15 is a non-contact, white light interferometer image that shows the surface topography of a 4 mm×4 mm portion of one of the plates SP2 shown in FIG. 14. The darker areas P142D being lower, representing areas devoid of printed polymer and the lighter areas P142H higher, representing areas having a layer of printed polymer, as shown in the shading scale SS of FIG. 15. FIG. 16 is a 3D topography representation of the same portion of pattern P142 shown in FIG. 15, using the same light and dark coloring convention as FIG. 15.

Adhesion testing was performed on the patterns P141, P142, which proved to have good adhesion to the steel plates SP1, SP2, in that it did not delaminate with a typical tape test. Nano-mechanical tests showed an adhesion strength (lateral force and normal force) greater than the forces that are encountered at a roll bite (nip) during embossing.

An aluminum sheet was placed on top of the pattern P142 on the sample plate SP2 and subjected to compression in a press (only normal loading—no shear involved) and the pattern P142 embossed the aluminum sheet. FIG. 17 shows the surface topography of a sample aluminum surface AS1 embossed by pattern P142 shown in FIGS. 14-16. The darker areas AS1D being lower, representing areas depressed by the high portion P142H of pattern P142 and the lighter areas AS1H higher, representing areas corresponding to areas P142D that were not depressed, as shown in the shading scale SS of FIG. 17. FIG. 18 shows a 3D surface topography of the embossed surface AS1 shown in FIG. 17.

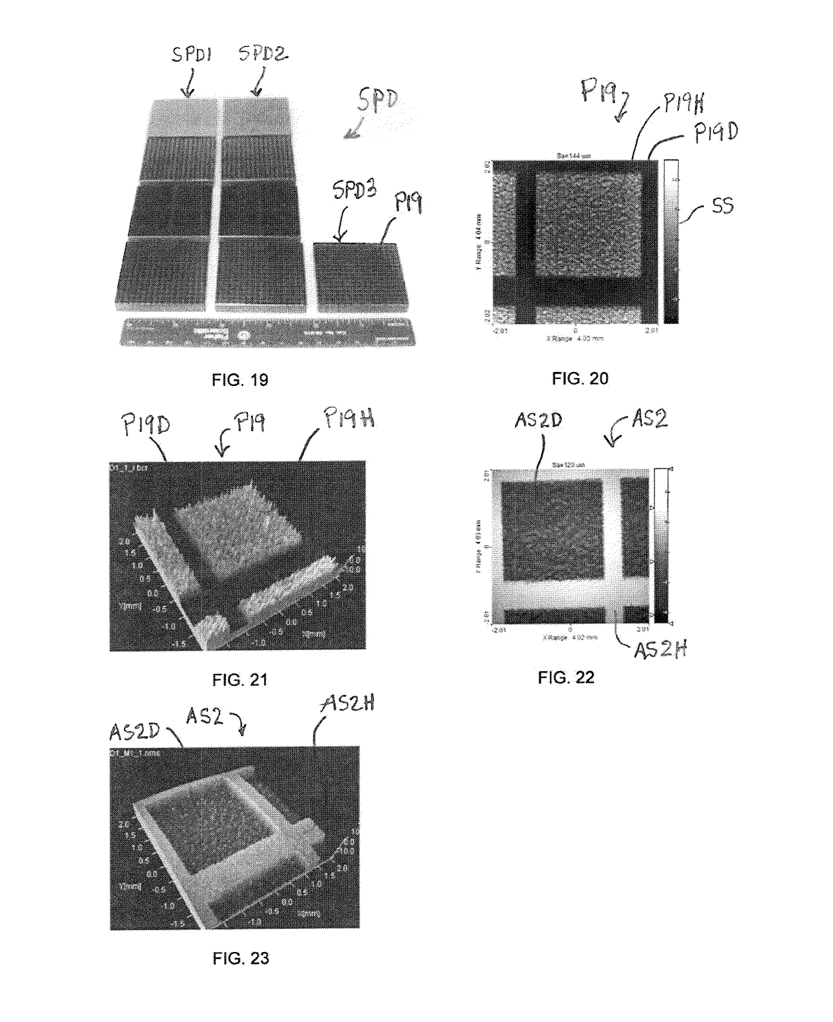

FIG. 19 shows a group of plates SPD upon which different embossing patterns have been printed in accordance with another embodiment of the present disclosure. Two plates SPD1, SPD2 are shown prior to printing of a pattern thereon. A third plate SPD3 has a pattern P19.

FIG. 20 shows the surface topography of a 4 mm×4 mm portion of pattern P19 of plate SPD3 shown in FIG. 19. The darker areas P19D being lower, representing areas devoid of printed polymer and the lighter areas P19H higher, representing areas having a layer of printed polymer, as shown in the shading scale SS of FIG. 20. FIG. 21 is a 3D surface topography of the portion of pattern P19 shown in FIG. 20, using the same light and dark coloring convention as FIG. 20.

An aluminum sheet was placed on top of the pattern P19 on the sample plate SPD3 and subjected to compression (only normal loading—no shear involved) and the pattern P19 embossed the aluminum sheet. FIG. 22 shows a surface topography of a sample aluminum surface AS2 embossed by pattern P19 shown in FIGS. 19-21. The darker areas AS2D being lower, representing areas depressed by the high portion P19H of pattern P19 and the lighter areas AS2H higher, representing areas corresponding to areas P19D that were not depressed, as shown in the shading scale SS of FIG. 22. FIG. 23 shows a 3D surface topography of the embossed surface AS2 shown in FIG. 22.

### Example 2

### Printing Media on Cylindrical Rolls

Media for forming an embossing pattern was printed onto cylindrical steel rolls using three approaches (a) direct print of an embossing pattern on the cylindrical roll; (b) printing of a seed layer on the roll, followed by printing an embossing pattern on top of seed layer; and (c) applying an adhesion promoter on the cylindrical roll, followed by applying a seed layer and then printing the pattern on the seed layer. An adhesion promoter is of the nature of a primer. A “seed layer” is an evenly applied layer of the printed media itself to form a base coat or foundation for the media that is printed in an embossing pattern. Instead of printing directly on the roll at various isolated elevations to form the embossing pattern, a first layer is applied to the entire external surface area of the roll. The isolated elevations/thicknesses of the embossing pattern are then printed on top of the seed layer. In this manner, the adhesion of the media to the roll is increased. The adhesion promoter performs a similar function, namely, increasing the adherence of the media to the roll, either in the case of adhering a seed layer to the roll or adhering an embossing pattern to the roll over an adhesion promoter.

Option (c) gave the best performance. While all three options passed an adhesion test where tape was applied over the printed pattern and then pulled, option (a) exhibited delamination of the pattern after embossing an alloy of 18 ksi yield strength. Option (b) exhibited pattern delamination while running a bench top rolling mill at high speed, i.e., generating large shear force. Both options (a) and (b) exhibited delamination of the pattern upon capturing the replica. In contrast, option (c) allowed the pattern to survive for alloys of yield strengths up to 30 ksi and the replica was captured without delaminating the pattern. Alloys with yield strength of 42 ksi caused the pattern to shatter.

A model No. CP100 UV Digital Cylindrical Press (can printer) available from INX International Ink Co. (inxinternational.com) was used to print the embossing pattern on steel cylindrical rolls. An Xaar 1002 print head available from Xaar of Cambridge, U.K. (Xaar.com) was used to apply experimental RDE 970B media available from INX International was used as the print media. This is a UV curable polymer equivalent to a clear coat on a can. Only a very small amount of media was needed to print on the roll, but at least 1 liter is required to fill the feed lines of the printer or else problems for print heads arise due to air in the lines. The droplet size for printing was about 6-42 μl (depending on the quality of print needed). The print quality that may be achieved with this set-up is up to 720×1000 dpi

Printing was conducted helically with the print head and roll moving constantly relative to the other in a single pass. The thickness of the printing at a specific location was controlled by controlling the volume of media dispensed at that location, rather than by building a desired thickness over multiple passes as would be done in index printing. In this manner, the embossing pattern having variations in height/thickness may be printed in a single continuous pass.

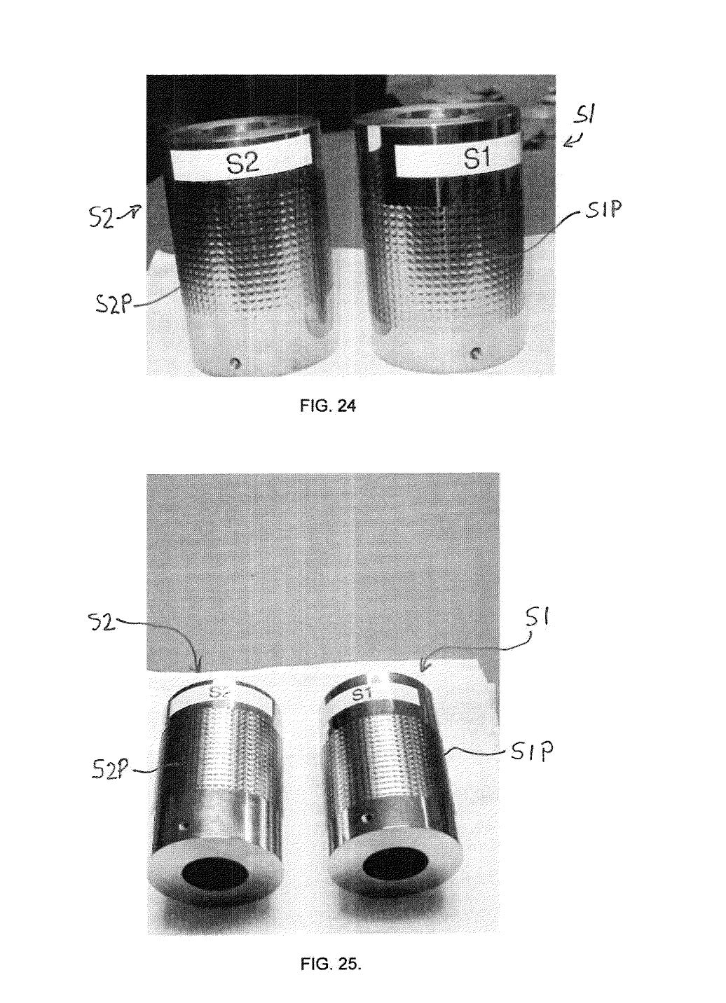

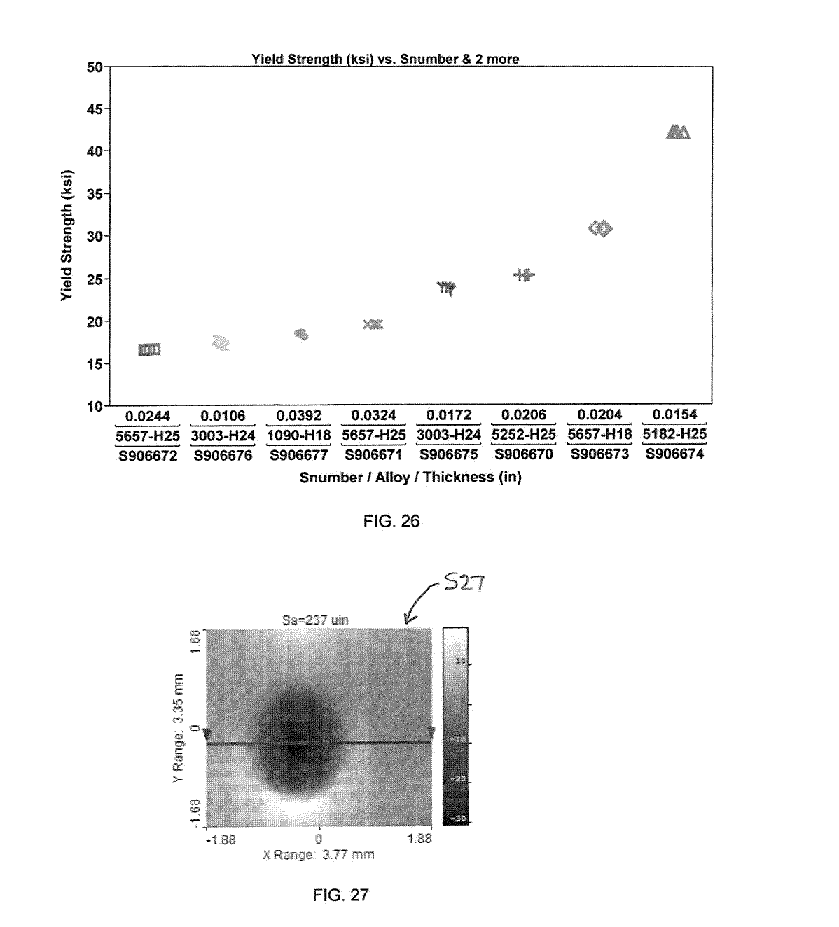

FIGS. 24 and 25 show rolls S1, S2, an outer surface of which is printed with an embossing pattern S1P, S2P, respectively, as described above. Each of the rolls S1P, S2P was substantially identical and each was incorporated into an embossing machine like that of FIG. 1, e.g., replacing roll 14, and used to emboss different sample sheets of aluminum, like sheet 18 of FIG. 1. A variety of different aluminum alloys and sheet thicknesses were embossed. FIG. 26 shows a graph of yield strength for the different alloys and thicknesses tested by embossing with the embossing patterns S1P, S2P. Along the x axis, the different alloys are identified by serial number, e.g., 5657-H2 and thickness, e.g., 0.0244 inches. A sample identification number, e.g., S906672 is also listed for each alloy.

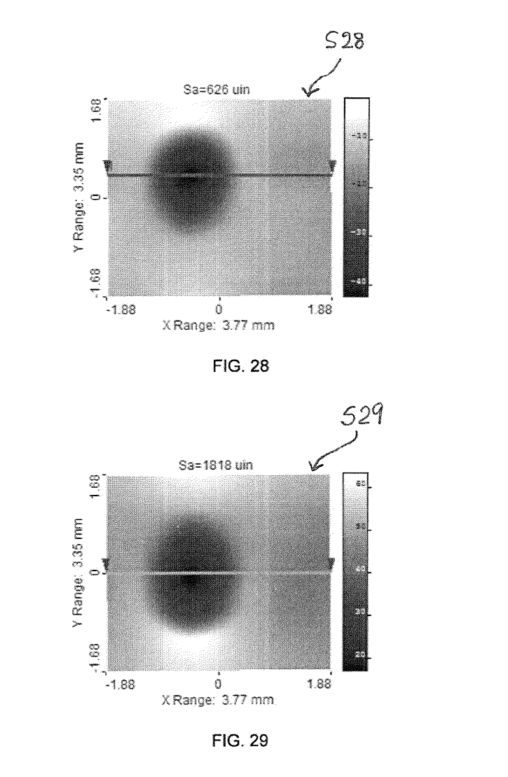

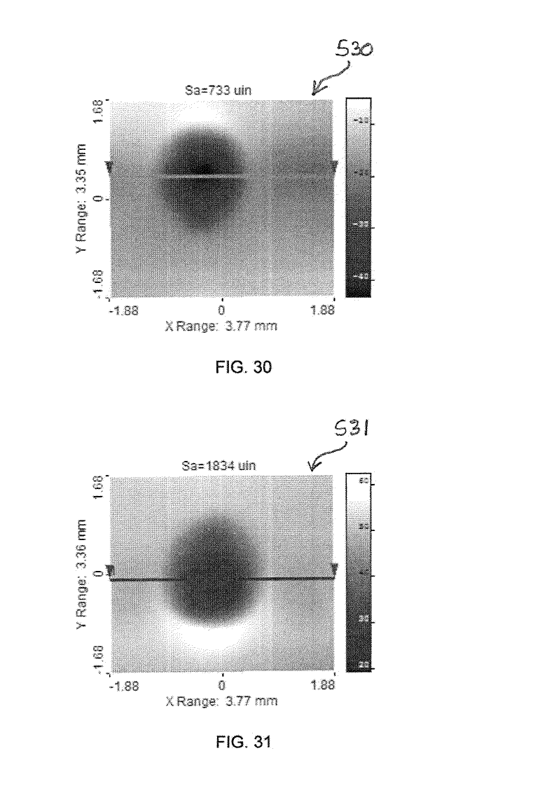

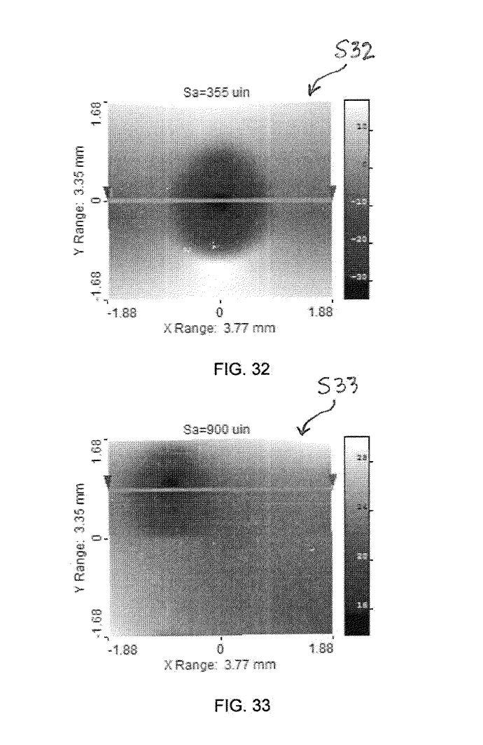

FIGS. 27-33 show plots S27, S28, S29, S30, S31, S32, S33, respectively, of surface topography for portions of sample surfaces made from the different alloys and embossed by the rolls 51, S2 of FIGS. 24 and 25. The X-axis (millimeters) is the width of the embossed pattern and Z-axis shown in the side scale (in micrometer) is the depth of the embossed pattern. As in the case of the flat patterns, e.g., P141, described above, an elevation on the roll patterns S1P, S2P corresponds to a depression in the embossed sheet surface). The dark regions in the image of FIGS. 27-33 correspond to valleys and bright regions correspond to peaks. The height scale is given on the side of each image. The horizontal lines are to acquire the profile across the embossed area. More specifically, the plots correspond to the following alloys: S27: 5657-H25, S28: 1090-H18, S29: 5657-H25, S30: 3003-H24, S31: 5252-H25, S32: 5657-H18, S33: 5182-H25.

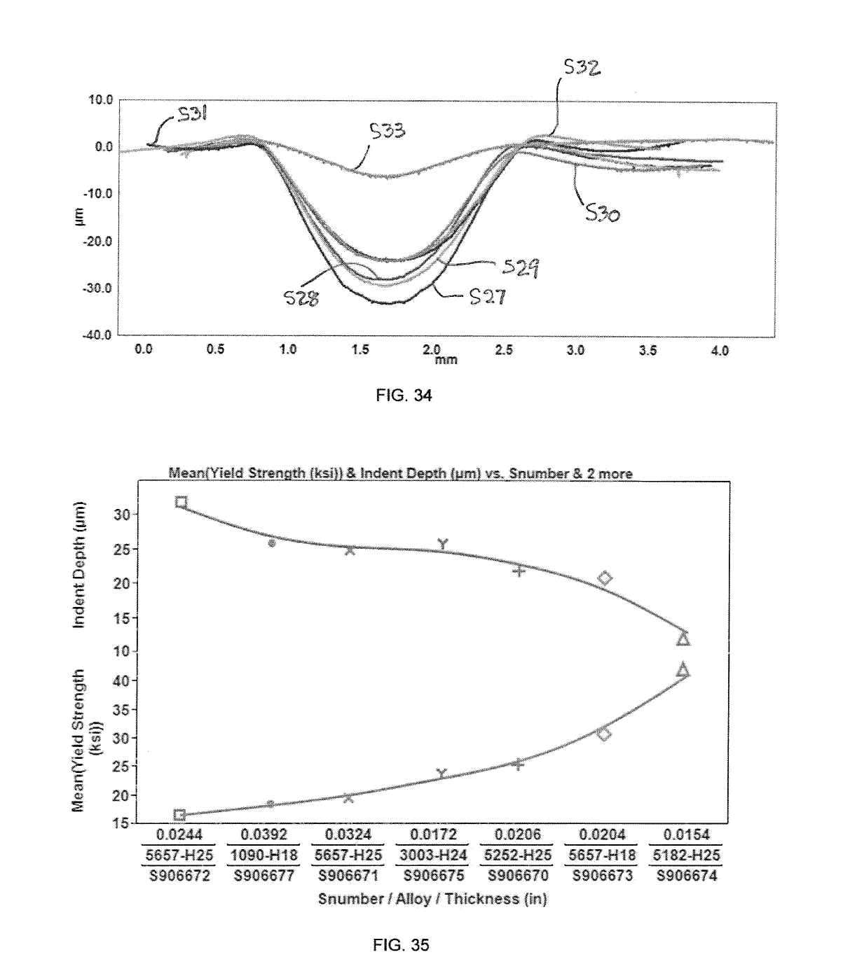

FIG. 34 shows a graph of indentation depth for the different sample surfaces of different alloys referred to in FIGS. 27-33 and identified by the plot references numbers S27-S33 used in FIGS. 27-33. Increasing alloy strength is associated with deceasing indentation depth. This indicates that media of a particular strength may be suitable for embossing an alloy of a particular strength, but may not be suitable for alloys having greater strength, which would require stronger media to the be used to form the embossing pattern. FIG. 35 is a graph of indentation depth and yield strength for different alloys of different thicknesses.

At the end of testing of the rolls S1 and S2, the patterns S1P and S2P were removed by the application of a commercially available alkaline cleaners (by Henkel) without damaging the rolls S1, S2 and allowing reuse.

It will be understood that the embodiments described herein are merely exemplary and that a person skilled in the art may make many variations and modifications without departing from the spirit and scope of the invention. For instance, the applique 12 may be formed as a solid prior to being adhered to the embossing element, such as a sheet 440 or work roll 14. In one embodiment, the appliques 12 may be printed on a first sheet, tackified by application of a solvent or adhesive and transferred to a work sheet 440 or work roll 14 upon contact.

In another embodiment, a mask/stencil may be utilized to form the appliques 12, which may be applied by spraying, brushing, or roll coating, coating the work roll 14 exposed by voids in the mask and retained on the work roll 14 or a sheet after the mask is withdrawn or dissolved. The mask may be a separate element that is formed and then applied to the work roll or may be printed on the work roll by 3D printing. Alternatively, the mask may be formed by photolithography. All such variations and modifications are intended to be included within the scope of the claims.

We claim:

1. A method for embossing a material, comprising the steps of:
depositing media on an embossing element;
pressing the embossing element with deposited media into the material.

2. The method of claim 1, wherein the media is applied to the embossing element in a flowable state and hardens prior to the step of pressing.

3. The method of claim 2, wherein the material is in the form of a sheet, the embossing element is a work roll and the media is deposited on the work roll by printing.

4. The method of claim 3, wherein the printing is 3D printing.

5. The method of claim 4, further including the step of removing the media from the work roll after pressing.

6. The method of claim 5, further comprising the step of printing more media on the work roll after the step of removing and then embossing material with the work roll.

7. The method of claim 6, wherein the media is digitally dispensable ink jet printable polymer and the step of removing includes exposing the media to an alkaline cleaner.

8. The method of claim 7, wherein, the sheet is made from aluminum alloy.

9. The method of claim 3, wherein the work roll is a first work roll and further comprising the step of depositing media on a second work roll and embossing the sheet on two sides by passing the sheet between the first and second work rolls.

10. The method of claim 2, wherein the embossing element is a web and the step of pressing is conducted by positioning the web with deposited media next to the sheet and passing the web and the sheet through a pair of work rolls.

11. The method of claim 10, further comprising the step of depositing media on a second web and positioning the second web next to the sheet, distal to the first web and the passing the first web, the second web and the sheet though the pair of work rolls.

12. The method of claim 10, wherein the web is paper.

13. A method for embossing a sheet of material comprising the steps of:
depositing media in a flowable state on the sheet of material;
allowing the media to harden;
pressing the hardened media into the sheet of material; and
removing the hardened media from the sheet, leaving depressions therein.

14. The method of claim 13, wherein the step of depositing is conducted by 3D printing.

15. The method of claim 13, wherein the media is digitally dispensable ink jet printable polymer and the hardened media is removed by exposure to alkaline cleaner.

16. The method of claim 4, wherein the step of depositing includes the step of metering a volume of media for each pixel of a plurality of pixels forming an embossing pattern.

17. An apparatus for embossing a sheet, comprising:
an embossing substrate;
a dispenser for dispensing media on the embossing substrate; and
an apparatus to press the embossing substrate with applied media into the sheet.

18. The apparatus of claim 17, wherein the dispenser is a 3D printer.

19. The apparatus of claim 18, wherein the embossing substrate is a work roll and the apparatus to press the embossing substrate is a rolling mill.

20. The apparatus of claim 18, wherein the embossing substrate is a flexible web and the apparatus to press the embossing substrate is a rolling mill.

21. The apparatus of claim 18, further comprising a media remover having a dispenser of alkaline cleaner that dissolves the media when the media is exposed thereto.

22. The apparatus of claim 18, wherein the embossing substrate is a plate and the apparatus to press the embossing substrate is a press.

23. The apparatus of claim 19, further comprising a layer of adhesion promoter applied to the embossing substrate and a seed layer of media disposed over the adhesion promoter upon which the media is dispensed to form an embossing pattern.

24. The apparatus of claim 17, wherein the media is UV curable.
